(19) United States
(12) Patent Application Publication
(10) Pub. No.: US 2026/0244663 A1
(43) Pub. Date: Aug. 20, 2026

(54) METHOD FOR SEARCHING DOCUMENT USING ARTIFICIAL INTELLIGENCE-BASED TRIPLE HELIX METHOD AND METHOD FOR PROVIDING REPORT AND CHATBOT SERVICE USING SAME

(71) Applicant: CodeCrain LTD., Seoul (KR)

(72) Inventors: Haeyong Shin, Seoul (KR); Junic Kim, Seoul (KR)

(21) Appl. No.: 19/058,244

(22) Filed: Feb. 20, 2025

(51) Int. Cl. G06F 16/3332; G06F 16/3329; G06F 16/353

(52) U.S. Cl. CPC G06F 16/3334; G06F 16/33295; G06F 16/353

(57) ABSTRACT

The present invention relates to a method for searching a document using an artificial intelligence-based triple helix method and a method for providing a report and a chatbot service using the same, and more specifically, to a method for searching a document using an artificial intelligence-based triple helix method and a method for providing a report and a chatbot service using the same, which derive keywords and a weight for each keyword from a question text received from a user terminal, derive final candidate documents related to the question text based on the keywords, the weight for each keyword, a similarity to the question text, and a score derived from metadata, and generate a report based on the final candidate documents.

### BACKGROUND OF THE INVENTION

### 1. Field of the Invention

The present invention relates to a method for searching a document using an artificial intelligence-based triple helix method and a method for providing a report and a chatbot service using the same, and more specifically, to a method for searching a document using an artificial intelligence-based triple helix method and a method for providing a report and a chatbot service using the same, which derive keywords and a weight for each keyword from a question text received from a user terminal, derive final candidate documents related to the question text based on the keywords, the weight for each keyword, a similarity to the question text, and a score derived from metadata, and generate a report based on the final candidate document.

### 2. Description of the Related Art

Existing academic information search engines simply rely on keyword-based search and have limitations in processing long natural language-type queries. In particular, there are problems such as not accurately reflecting the intention of user's questions or deriving results including unnecessary information. Therefore, a user has difficulty in taking a lot of time and labor forceaa, such as inputting keywords and manually reviewing documents derived as search results to filter documents with low relevance.

Recently, attempts have been made to analyze the user's intention and provide highly relevant results using a large language model (LLM) or a traditional NLP technique. In this case, by automatically searching and analyzing relevant academic information about a question input of the user in a natural language, when a document suitable for the user's intention is found or a report is generated and provided based on a reliable document, efficiency of access to academic information may be significantly improved. A simple answer according to the user's request is provided, and a reliable document is provided or a report is generated based on the academic information, so that the user may obtain an in-depth understanding of a specific research topic and quickly respond to various questions generated during the research process.

In this situation, there is a demand for a technology capable of accurately grasping the intent included in the user's question using artificial intelligence, automatically searching and analyzing a document related to the question input by the user, providing a high-quality document based on a semantic similarity of the paper, the influence of the journal, the number of citations, and the like, and automatically generating a report based on a reliable document.

### SUMMARY OF THE INVENTION

An object of the present invention is to provide a method for searching a document using an artificial intelligence-based triple helix method and a method for providing a report and a chatbot service using the same, and more specifically, to a method for searching a document using an artificial intelligence-based triple helix method and a method for providing a report and a chatbot service using the same, which derive keywords and a weight for each keyword from a question text received from a user terminal, derive final candidate documents related to the question text based on the keywords, the weight for each keyword, a similarity to the question text, and a score derived from metadata, and generate a report based on the final candidate document.

To solve the above problems, one embodiment of the present invention provides a document search method including: a keyword deriving step of deriving keywords from each of one or more clusters included in a question text received from a user terminal, and deriving a weight for each keyword based on a frequency of each keyword included in the cluster; a first candidate document deriving step of deriving a predetermined first number of first candidate documents by searching first areas of a plurality of documents based on the keywords and the weight for each keyword; a second candidate document deriving step of deriving a predetermined second number of second candidate documents based on a first similarity between a second area of the first candidate document and the cluster; a third candidate document deriving step of deriving a predetermined third number of third candidate documents based on a score derived from metadata of the second candidate document; and a final candidate document deriving step of deriving final candidate documents based on a second similarity between a third area of the third candidate document and the cluster, in which the third area corresponds to an area larger than the first area or an area in which specific contents are written, and the third area corresponds to an area larger than the second area or an area in which specific contents are written.

According to one embodiment of the present invention, the keyword deriving step may include: a step of receiving a question text from the user terminal through a search interface; a step of separating the question text into one or more clusters by inputting the question text into a cluster division model; a step of deriving keywords from each of the one or more clusters by inputting each of the clusters into a large language model that is located outside or inside a server system; and a step of deriving a weight for each keyword based on a frequency of the keywords included in the question text.

According to one embodiment of the present invention, the first area may include a title and an abstract of the document, the second area may include a title of the document, and the third area may include a full text of the document.

According to one embodiment of the present invention, the second candidate document deriving step may include: a step of inputting a title of the first candidate document and an entire cluster into a large language model that is located outside or inside a server system; a step of deriving a first similarity between the title of each of the first candidate documents and the cluster through the large language model; and a step of deriving a predetermined second number of second candidate documents from the first candidate documents based on the first similarity.

According to one embodiment of the present invention, the third candidate document deriving step may include: a step of extracting metadata from each of the second candidate documents by inputting the second candidate documents into a large language model that is located outside or inside a server system; a step of calculating a journal score and a cited score for each of the second candidate documents based on the metadata; and a step of deriving a predetermined third number of third candidate documents from the second candidate documents based on the journal score and the cited score.

According to one embodiment, the final candidate document deriving step may include: a step of inputting a full text of the third candidate document and an entire cluster into a large language model that is located outside or inside a server system; a step of deriving a second similarity between each of the third candidate documents and the cluster through the large language model; and a step of deriving a final candidate document from the third candidate documents based on the second similarity.

According to one embodiment, the document search method may further include: a report providing step of providing a report generated based on the final candidate document to the user terminal, in which the report providing step may include: a step of inputting the question text, a text included in the final candidate document, and a request prompt including a request for data to generate a report on the question text into a large language model; a step of receiving a plurality of answer phrases and source information about each answer phrase from the large language model, and generating a report on the question text based on the plurality of answer phrases and the source information; and a step of providing the report to the user terminal.

According to one embodiment of the present invention, it is possible to derive final candidate documents related to the question text from the plurality of documents.

According to one embodiment of the present invention, it is possible to generate a report based on the final candidate documents through the large language model.

According to one embodiment of the present invention, it is possible to extract a document having a high similarity with the question text by calculating the first similarity and the second similarity.

According to one embodiment of the present invention, it is possible to verify reliability of the document by deriving a score from metadata of the document.

According to one embodiment of the present invention, it is possible to search a document related to the question text by deriving keywords from the question text.

According to one embodiment, it is possible to verify reliability of the report through source information about the final candidate document referenced by the report.

According to one embodiment of the present invention, a user may provide a related document by inputting the question text through the search interface.

According to one embodiment, it is possible to derive a first similarity, a second similarity, and metadata through the large language model.

According to one embodiment of the present invention, it is possible to calculate a journal score and a cited score based on metadata of the document.

### BRIEF DESCRIPTION OF THE DRAWINGS

FIGS. 1A and 1B are views schematically illustrating a connection configuration and an internal configuration of a server system according to one embodiment of the present invention.

FIG. 2 is a view schematically illustrating a step of performing a method for searching a document according to one embodiment of the present invention.

FIGS. 3A and 3B are views schematically illustrating a search interface according to one embodiment of the present invention.

FIG. 4 is a view schematically illustrating a process of performing a keyword deriving step according to one embodiment of the present invention.

FIGS. 5A and 5B are views schematically illustrating a process of performing a first candidate document deriving step according to one embodiment of the present invention.

FIG. 6 is a view schematically illustrating a process of performing a first similarity deriving step according to one embodiment of the present invention.

FIG. 7 is a view schematically illustrating a process of performing a second candidate document deriving step according to one embodiment of the present invention.

FIG. 8 is a view schematically illustrating a process of performing a third candidate document deriving step according to one embodiment of the present invention.

FIG. 9 is a view schematically illustrating a process of performing a second similarity deriving step according to one embodiment of the present invention.

FIG. 10 is a view schematically illustrating a process of performing a final candidate document deriving step according to one embodiment of the present invention.

FIG. 11 is a view schematically illustrating a process of performing a report providing step according to one embodiment of the present invention.

FIG. 12 is a view schematically illustrating a report according to one embodiment of the present invention.

FIGS. 13A-13C are views schematically illustrating a chatbot interface according to one embodiment of the present invention.

FIG. 14 is a view schematically illustrating a search filter interface according to one embodiment of the present invention.

FIG. 15 is a view schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

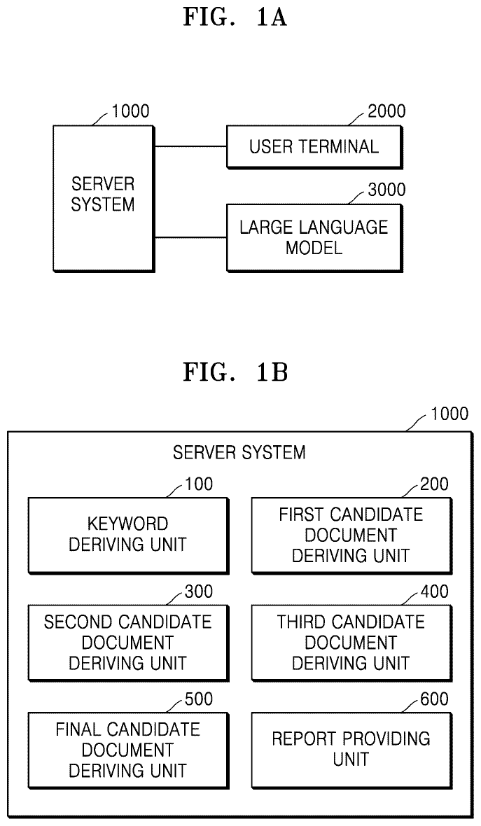

FIGS. 1A and 1B are views schematically illustrating a connection configuration and an internal configuration of a server system 1000 according to one embodiment of the present invention.

Schematically, FIG. 1A illustrates a connection configuration of the server system 1000, and FIG. 1B illustrates an internal configuration of the server system 1000.

Specifically, FIG. 1A illustrates a connection configuration between the server system 1000, a user terminal 2000, and a large language model 3000 for performing the document search method.

The document search method may be performed by the server system 1000 including one or more processors and one or more memories, and as illustrated in FIG. 1A, the server system 1000 may perform the document search method in communication with the user terminal 2000 and the large language model 3000.

In this case, the server system 1000 may receive a question text from the user terminal 2000, and may provide final candidate documents related to the question text and a report on the question text to the user terminal 2000. The server system 1000 may extract keywords by inputting a cluster for the question text into the large language model 3000, may derive a first similarity by inputting a title of the first candidate document and the cluster, may extract metadata by inputting the second candidate document, may derive a second similarity by inputting the full text of the third candidate document and the cluster, and may generate an answer phrase and source information for generating a report by inputting the question text, the final candidate document, and the request prompt.

According to one embodiment of the present invention, the connection configuration of the user terminal 2000 and the server system 1000 may include an access to the server system 1000 through the user terminal 2000 that includes a computer or a portable terminal used by a user. The large language model 3000 may be located inside or outside the server system 1000.

In addition, a plurality of documents may be stored in an academic information database located inside or outside the server system 1000, and the academic information database may correspond to a database capable of searching academic information including domestic or foreign papers, journals, journals, books, reports, pamphlets, posters, images, and newspaper articles containing research results in the academic field and collecting digitalized related documents. The large language model 3000 may derive keywords based on the input information, derive a similarity, extract metadata, or generate data including the answer phrases and source information for generating a report, and may be located inside or outside the server system 1000.

As illustrated in FIG. 1B, the server system 1000 may include: a keyword deriving unit 100 that performs a keyword deriving step of deriving keywords from each of one or more clusters included in the question text received from the user terminal 2000 and deriving a weight for each keyword based on a frequency of each keyword included in the cluster; a first candidate document deriving unit 200 that performs a first candidate document deriving step of deriving a predetermined first number of first candidate documents by searching first areas of a plurality of documents based on the keywords and the weight for each keyword; a second candidate document deriving unit 300 that performs a second candidate document deriving step of deriving a predetermined second number of second candidate documents based on a first similarity between a second area of the first candidate document and the cluster; a third candidate document deriving step of deriving a predetermined third number of third candidate documents based on a score derived from metadata of the second candidate document; a final candidate document deriving unit 500 that performs a final candidate document deriving step of deriving final candidate documents based on a second similarity between a third area of the third candidate document and the cluster; and a report providing unit 600 that performs a report providing step of providing a report generated based on the final candidate documents to the user terminal 2000.

More specifically, each configuration included in the server system 100 illustrated in FIG. 1B serves to control an operation of the server system 1000 that performs the document search method of the present invention.

The keyword deriving unit 100 of the server system 1000 may derive keywords from each of one or more clusters included in the question text received from the user terminal 2000, and may derive a weight for each keyword based on a frequency of each keyword included in the cluster.

According to one embodiment of the present invention, the keyword deriving step may include: a step of receiving a question text from the user terminal 2000 through a search interface; a step of separating the question text into one or more clusters by inputting the question text into a cluster division model; a step of deriving keywords from each of the one or more clusters by inputting each of the clusters into the large language model 3000 that is located outside or inside the server system 1000; and a step of deriving a weight for each keyword based on a frequency of the keywords included in the question text.

The first candidate document deriving unit 200 of the server system 1000 may derive a predetermined first number of first candidate documents by searching first areas of a plurality of documents based on the keywords and the weight for each keyword.

According to one embodiment of the present invention, the first candidate document may be derived according to the keywords that are included in first areas including titles and abstracts of the plurality of documents, and in this case, a large number of documents may be included in the first candidate document in descending order of the weight for each keyword.

The first candidate document deriving unit 300 of the server system 1000 may derive a predetermined second number of second candidate documents based on a first similarity between a second area of the first candidate document and the cluster.

According to one embodiment, the second candidate document deriving step may include: a step of inputting a title of the first candidate document and the entire cluster into the large language model 3000 that is located outside or inside the server system 1000; a step of deriving a first similarity between the title of each of the first candidate documents and the cluster through the large language model 3000; and a step of deriving a predetermined second number of second candidate documents from the first candidate documents based on the first similarity.

The third candidate document deriving unit 400 of the server system 1000 may derive a predetermined third number of third candidate documents based on a score derived from metadata of the second candidate document.

According to one embodiment, the third candidate document deriving step may include: a step of extracting metadata from each of the second candidate documents by inputting the second candidate documents into the large language model 3000 that is located outside or inside the server system 1000; a step of calculating a journal score and a cited score for each of the second candidate documents based on the metadata; and a step of deriving a predetermined third number of third candidate documents from the second candidate documents based on the journal score and the cited score.

The final candidate document deriving unit 500 of the server system 1000 may derive final candidate documents based on a second similarity between a third area of the third candidate document and the cluster.

According to one embodiment, the final candidate document deriving step may include: a step of inputting a full text of the third candidate document and the entire cluster into the large language model 3000 that is located outside or inside the server system 1000; a step of deriving a second similarity between each of the third candidate documents and the cluster through the large language model 3000; and a step of deriving final candidate documents from the third candidate documents based on the second similarity.

The report providing unit 600 of the server system may provide a report generated based on the final candidate document to the user terminal 2000.

According to one embodiment, the report providing step may include: a step of inputting the question text, a text included in the final candidate document, and a request prompt including a request for data to generate a report on the question text into the large language model 3000; a step of receiving a plurality of answer phrases and source information about each answer phrase from the large language model 3000, and generating a report on the question text based on the plurality of answer phrases and the source information; and a step of providing the report to the user terminal 2000.

In addition, the report includes: a subject layer L4 including contents of the corresponding question text; a body text layer L5 including contents of the plurality of answer phrases; a source layer L6 including source information about the plurality of answer phrases; and a source element E1 displaying a number for each source information included in the source layer L6, in which the source information corresponds to a source for the final candidate document.

Preferably, the third area may correspond to an area larger than the first area or an area in which specific contents are written, the third area may correspond to an area larger than the second area or an area in which specific contents are written, the first area may include the tile and abstract of the document, the second area may include the title of the document, and the third area may include the full text of the document.

According to one embodiment of the present invention, in the document search method, the order in which the second candidate document deriving step, the third candidate document deriving step, and the final candidate document deriving step are performed may be interchanged, or one or more steps of the second candidate document deriving step, the third candidate document deriving step, and the final candidate document deriving step may be omitted.

For example, in the document search method, the keyword deriving step, the first candidate document deriving step, the second candidate document deriving step, the third candidate document deriving step, the final candidate document deriving step, and the report providing step may be performed in order, or the keyword deriving step, the first candidate document deriving step, the third candidate document deriving step, the final candidate document deriving step, and the report providing step may be performed in order without the second candidate document deriving step.

In addition, when the final candidate document is derived through the document search method of the present invention, a report may be automatically generated based on the final candidate document and provided to the user terminal 2000, or an answer may be provided to the user through a chatbot based on the final candidate document. Therefore, according to the present invention, by providing a chatbot service to the user terminal 2000, the user may input a question text through a chat with the chatbot, receive a final candidate document related to the question text, and receive a report generated based on the final candidate document.

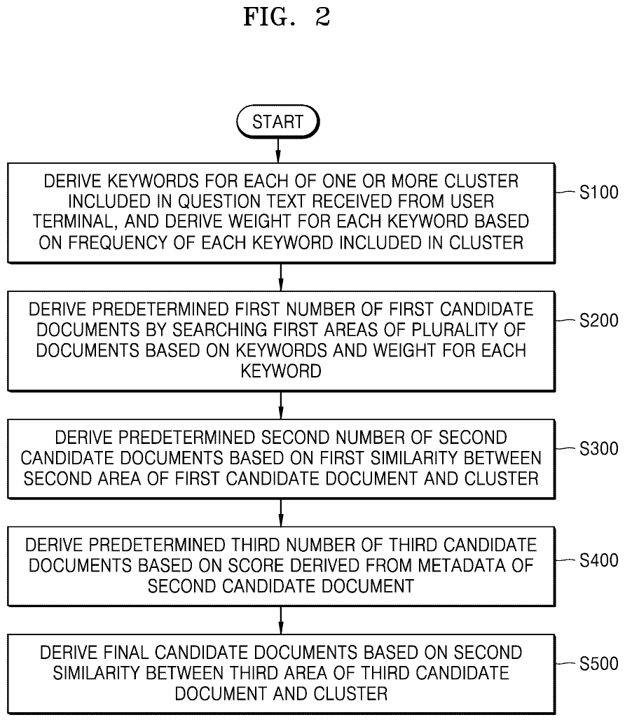

FIG. 2 is a view schematically illustrating a step of performing a method for searching a document according to one embodiment of the present invention.

As illustrated in FIG. 2, in the document search method, the question text received from the user terminal 2000 may be divided into one or more clusters, keywords may be derived from each of one or more clusters through the large language model 3000, a weight for each keyword may be derived based on a frequency of each keyword included in the cluster (S100), and a first area including titles and abstracts of a plurality of documents may be searched based on the keywords and the weight for each keyword to derive a predetermined first number of first candidate documents (S200).

Thereafter, after deriving the first similarity between the cluster and the second area including the title of the first candidate document through the large language model 3000, a predetermined second number of second candidate documents may be derived from the first candidate documents based on the first similarity (S300), and after extracting metadata from the second candidate document through the large language model 3000, a predetermined third number of third candidate documents may be derived from the second candidate documents based on a score including a journal score and a cited score, which are derived from the metadata of the second candidate document (S400).

In addition, after deriving the second similarity between the cluster and a third area including the full text of the third candidate document through the large language model 3000, final candidate documents may be derived from the third candidate documents based on the second similarity (S500).

According to one embodiment, the question text, a text included in the final candidate document, and a request prompt including a request for data to generate a report on the question text may be input into the large language model 3000 to receive a plurality of answer phrases and source information about each answer phrase from the large language model 3000, and a report on the question text may be generated based on the plurality of answer phrases and the source information to provide the report to the user terminal 2000.

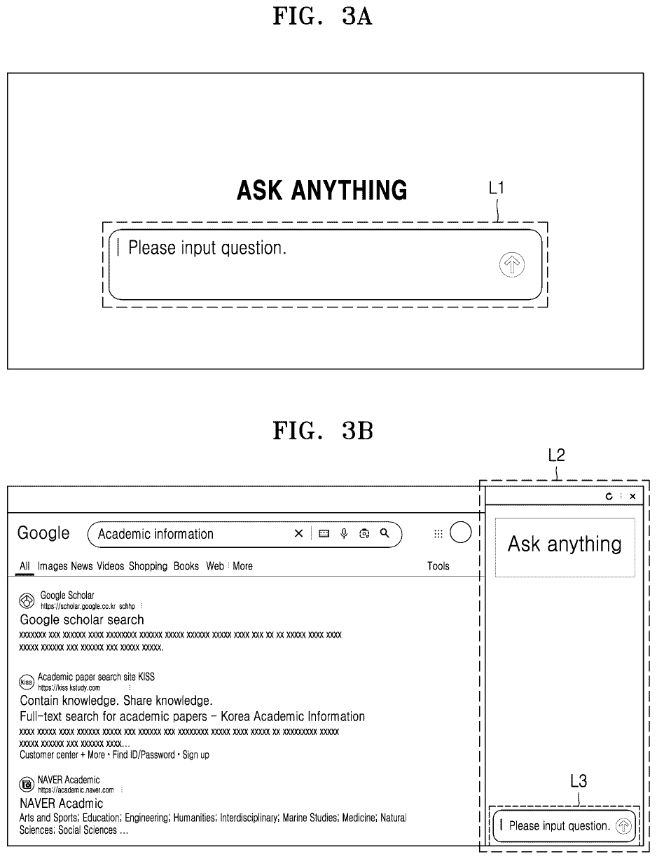

FIGS. 3A and 3B are views schematically illustrating a search interface according to one embodiment of the present invention.

Schematically, FIG. 3A illustrates a first search interface, and FIG. 3B illustrates a second search interface.

Specifically, the search interface may include a first search interface displayed on the user terminal 2000 as one web page or one application to search a document, and a second search interface displayed on the user terminal 2000 in a pop-up form to search a document, in which the first search interface may include a first question input layer L1 for receiving the question text from the user terminal 2000, and the second search interface may include a second search layer L2 displayed on the user terminal 2000 in a pop-up form to search a document and a second question input layer L3 for receiving the question text from the user terminal 2000.

Preferably, the search interface is an interface through which the user terminal 2000 may input a question, receive a final candidate document related to a question from the server system 1000, receive a report referring to the final candidate document, and receive an answer to the question, and the user may chat with the server system 1000 through the search interface.

As illustrated in FIG. 3A, the first question input layer L1 may receive the question text from the user terminal 2000, and may correspond to a screen that is first displayed when the first search interface is displayed on the user terminal 2000. A user who has been provided with the first search interface may input a research-related question in a text form through the first question input layer L1.

As illustrated in FIG. 3B, the second search layer L2 may be displayed in a pop-up form while another web page or another application is displayed on the user terminal 2000, or the second search layer L2 may be displayed by dividing the screen of the user terminal 2000, and the second search layer L2 may correspond to a screen that is first displayed when the second search interface is displayed on the user terminal 2000. The second question input layer L3 may receive the question text from the user terminal 2000, and a user who has been provided with the second search interface may input a research-related question in the form of a text through the second question input layer L3.

Preferably, the pop-up form may include a chatbot form such as a conventional chatbot technology, a form of an interactive interface or dialog window, a form of an extension program entering a browser, a form embedded in a website, and the like.

In this case, the user may upload a file through the search interface, and the server system 1000 may automatically generate the question text based on the file. The file may include a file in formats such as image, excel, docx, or pdf.

More specifically, when the user uploads only the file through the search interface, the server system 1000 may parse the text from the file and input the parsed text to the large language model 3000 that is located outside or inside the server system 1000 to generate a question text based on the parsed text. Alternatively, when the user inputs the file and the question text together through the search interface, the server system 1000 may parse the text from the file and input the parsed text and the question text to the large language model 3000 that is located outside or inside the server system 1000 to generate a final question text based on the parsed text and the question text.

According to one embodiment of the present invention, when the search interface as illustrated in FIGS. 3A and 3B is included in a specific website and provided to the user, the user may search other information included in the website rather than a document through the search interface. For example, when a library website includes the search interface, the user may input a question text for a document of the library through the search interface, but may search an operating time of the library through the search interface and receive an answer thereto.

In addition, according to one embodiment of the present invention, the user may select a search target language when inputting the question text through the search interface. In this case, when the search target language is selected as one language, documents related to the corresponding language may be searched, and when the language to be searched is selected as a plurality of languages, documents related to each of the plurality of corresponding languages may be searched.

For example, when the search target language is selected by the user in three languages, the question text may be translated into three corresponding languages, and documents related to the question text may be searched for each language. Thereafter, all documents searched in three languages may be integrated and included in the final candidate document.

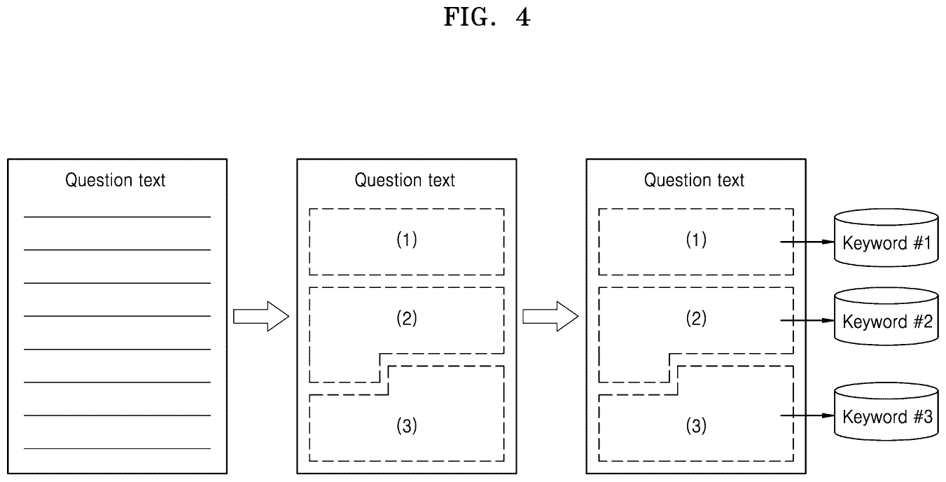

FIG. 4 is a view schematically illustrating a process of performing a keyword deriving step according to one embodiment of the present invention.

Schematically, in the keyword deriving step, keywords may be derived from each of one or more clusters included in a question text received from the user terminal 2000, and a weight for each keyword may be derived based on a frequency of each keyword included in the cluster.

Specifically, the keyword deriving step may include: a step of receiving a question text from the user terminal 2000 through a search interface; a step of separating the question text into one or more clusters by inputting the question text into a cluster division model; a step of deriving keywords from each of the one or more clusters by inputting each of the clusters into the large language model 3000 that is located outside or inside the server system 1000; and a step of deriving a weight for each keyword based on a frequency at which the keywords are included in the question text.

As illustrated in FIG. 4, when the question text is received from the user terminal 2000 or the question text is received, the server system 1000 may input the question text to the cluster division model to separate the question text into one or more clusters.

According to one embodiment of the present invention, the question text may include a question composed of one sentence or a question composed of a plurality of sentences. Accordingly, the question text may include a question on one subject and a question on a plurality of subjects.

In this case, the cluster division model corresponds to a model capable of dividing the text into one or more clusters when the text is input based on the large language model 3000, and may be located outside or inside the server system 1000. The cluster is a part of text included in one question text, and the cluster may be separated based on a paragraph, a sentence, a word, and the like. The one or more clusters correspond to text included in the question text, and may be the question text received from the user terminal 2000 when all of the one or more clusters are combined.

As illustrated in FIG. 4, one question text may be divided into three clusters including (1) to (3) through the cluster division model, and each of the three clusters may correspond to a part of the question text. In addition, keywords may be derived from each of the three clusters by inputting each of the three clusters into the large language model 3000.

Accordingly, each of keywords #1 to #3 may be derived from each cluster corresponding to (1) to (3). In this case, one keyword is derived in each of (1) to (3), but according to one embodiment of the present invention, when a plurality of subjects or a plurality of keywords are included in one cluster, the plurality of keywords may be derived in one cluster.

Thereafter, a weight for each keyword may be derived based on a frequency of a keyword including keywords #1 to #3, which is included in the question text. That is, the weight of each of keywords #1 to #3 may be derived based on a frequency of keyword #1 included in the question text, a frequency of keyword #2 included in the question text, and a frequency of keyword #3 included in the question text.

When keyword #1 is included in the question text five times, keyword #2 is included in the question text three times, and keyword #3 is included in the question text two times, the weight of keyword #1 may be derived as 0.5, the weight of keyword #2 may be derived as 0.3, and the weight of keyword #3 may be derived as 0.2.

For example, when a question text including a text “latest research paper on the persistence of COVID-19 and antibody response” is input, keywords “COVID-19”, “antibody response”, “persistence”, and “latest research” may be extracted.

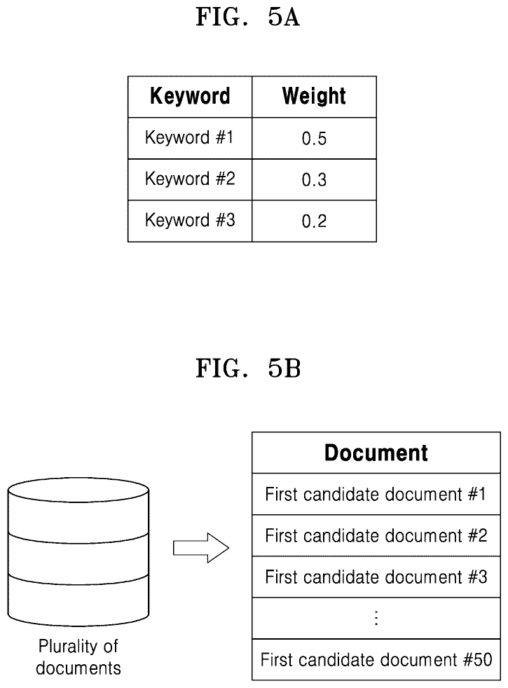

FIGS. 5A and 5B are views schematically illustrating a process of performing a first candidate document deriving step according to one embodiment of the present invention.

Schematically, FIG. 5A illustrates a process of performing a step of deriving a weight for each keyword, and FIG. 5B illustrates a process of performing a first candidate document deriving step.

Specifically, in the first candidate document deriving step, a predetermined first number of first candidate documents may be derived by searching first areas of a plurality of documents based on the keywords and the weight for each keyword.

Preferably, the weight for each keyword may correspond to a number indicating the importance of the corresponding keyword.

As illustrated in FIG. 5A, in the keyword deriving step, the keywords and the weight for each keyword may be derived, and the weight of each of keywords #1 to #3 may correspond to 0.5, 0.3, and 0.2, respectively.

As illustrated in FIG. 5B, the keywords may be searched in the first areas of the plurality of documents, and the first candidate document may be derived based on the weight for each keyword. In this case, the first area may include the title and abstract of the document, and may search keywords #1 to #3 in the titles and abstracts of the plurality of documents.

Accordingly, a document in which any one or more of keywords #1 to #3 are included in the titles and abstracts of the plurality of documents may be derived, and a predetermined first number of first candidate documents may be derived based on the weight of each of keywords #1 to #3.

According to one embodiment of the present invention, the first candidate document may be derived from an academic information database by searching the keywords in the academic information database in which the plurality of documents are stored. Therefore, the plurality of documents may include a document stored outside or inside the server system 1000.

When the predetermined first number correspond to 50, 50 first candidate documents including first candidate documents #1 to #50 may be derived. As described above, when the keywords are searched in the first areas of the plurality of documents, too many documents may be derived, but only 50 documents, which are the predetermined first number based on the weight for each keyword, may be derived as first candidate documents.

For example, when there are a plurality of documents including only one of keywords #1 to #3, 25 documents including keyword #1 may be derived as first candidate documents, 15 documents including keyword #2 may be derived as second candidate documents, and 10 documents including keyword #3 may be derived as first candidate documents based on the weight for each keyword.

However, when there are a plurality of documents including any one or more of keywords #1 to #3, weight scores for the plurality of documents may be calculated, and the predetermined first number of first candidate documents may be derived in descending order of the weight score.

For example, when any one of the plurality of documents includes all of keywords #1 to #3, and keyword #1 is included two times, keyword #2 is included three times, and keyword #3 is included one time in the title and abstract of the document, a weight score of (2*0.5)+(3*0.3)+(1*0.2)=2.1 may be calculated based on 0.5, 0.3, and 0.2, which are the weights of keywords #1 to #3, respectively.

In this way, the weight score for each of the plurality of documents including any one or more of keywords #1 to #3 may be calculated, and 50 first candidate documents may be derived in descending order of the weight score.

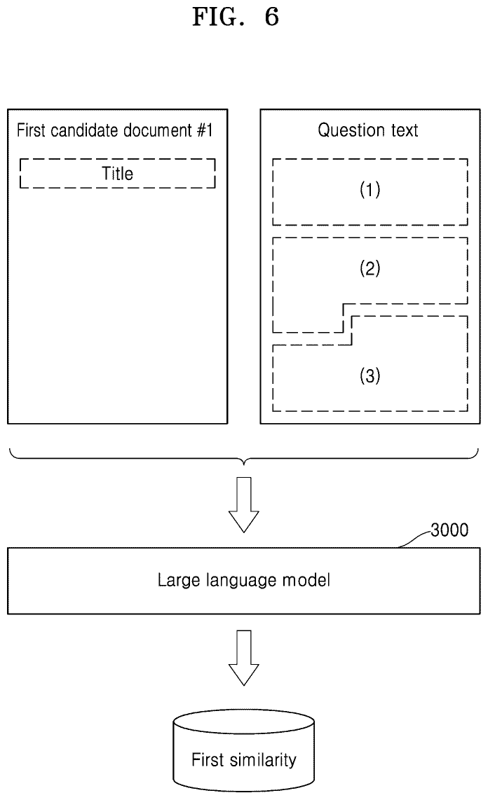

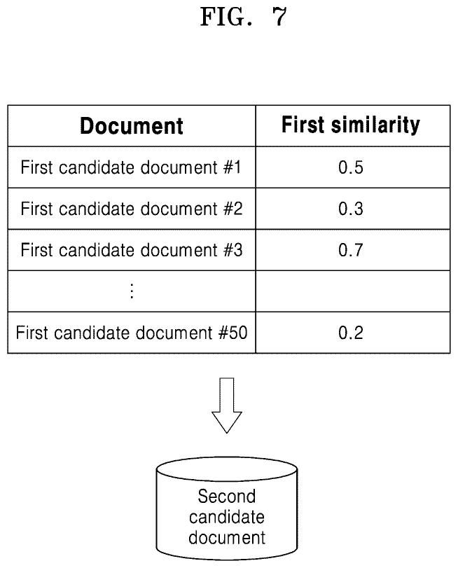

FIG. 6 schematically illustrates a process of performing a first similarity deriving step according to one embodiment of the present invention.

Schematically, in the second candidate document deriving step, a predetermined second number of second candidate documents may be derived based on a first similarity between a second area of the first candidate document and the cluster.

Specifically, the second candidate document deriving step may include: a step of inputting a title of the first candidate document and the entire cluster into the large language model 3000 that is located outside or inside the server system 1000; a step of deriving a first similarity between the title of each of the first candidate documents and the cluster through the large language model 3000; and a step of deriving a predetermined second number of second candidate documents from the first candidate documents based on the first similarity.

As illustrated in FIG. 6, the first similarity may be derived by inputting the title of the first candidate document and the entire cluster into the large language model 3000 that is located outside or inside the server system 1000. The first similarity corresponds to a similarity between the title of the first candidate document and the cluster, and it can be seen that the greater the first similarity, the greater the relevance between the corresponding first candidate document and the corresponding question text. Therefore, the accuracy of the first candidate document corresponding to the search result for the keywords may be determined through the first similarity.

According to one embodiment of the present invention, the first similarity may be derived by inputting each of the first number of first candidate documents and the question text into the large language model 3000, or the first similarity may be derived by inputting each of the first number of first candidate documents and each of clusters included in the question text into the large language model 3000. In this case, a prompt for calculating a similarity between the first candidate document and the question text may be input together into the large language model 3000.

For example, when there are 50 first candidate documents including first candidate documents #1 to #50 and the question text includes three clusters including (1) to (3), the first similarity may be derived by inputting first candidate document #1 and the entire question text into the large language model 3000, or the first similarity may be derived by inputting first candidate document #1 and cluster (1) into the large language model 3000, inputting first candidate document #1 and cluster (2) into the large language model 3000, and inputting first candidate document #1 and cluster (3) into the large language model 3000.

Preferably, the predetermined second number of second candidate documents may be derived in descending order of the first similarity from the first candidate documents.

In this case, according to one embodiment of the present invention, the first similarity may be automatically derived through the large language model 3000, or may be derived by calculating a cosine similarity based on embedding information about the title of the first candidate document and embedding information about the entire question text.

Therefore, the accuracy of the searched documents may be enhanced by excluding a document including the title less related to the question text through the first similarity.

FIG. 7 is a view schematically illustrating a process of performing a second candidate document deriving step according to one embodiment of the present invention.

Schematically, in the second candidate document deriving step, a predetermined second number of second candidate documents may be derived based on a first similarity between a second area of the first candidate document and the cluster.

As illustrated in FIG. 7, as for each of 50 first candidate documents including first candidate documents #1 to #50, a first similarity between the title of the first candidate document and the question text may be derived, and the first similarity each of first candidate document #1, first candidate document #2, and first candidate document #3 to first candidate document #50 may correspond to 0.5, 0.6, 0.7, . . . , 0.2, respectively.

The second area may include the title of the document, and the first similarity may be derived as a number between 0 and 1.

According to one embodiment of the present invention, the predetermined second number of second candidate documents may be derived in descending order of the first similarity from the 50 first candidate documents, and when the predetermined second number corresponds to 40, 40 second candidate documents may be derived in descending order of the first similarity from the first candidate documents.

Therefore, 40 second candidate documents including second candidate documents #1 to #40 may be derived.

However, according to another embodiment of the present invention, the first candidate document corresponding to the first similarity that is equal to or less than a predetermined first reference similarity may be excluded from the second candidate document. When the predetermined first reference similarity corresponds to 0.4, the first candidate document corresponding to the first similarity of equal to or less than 0.4 may be excluded from the second candidate document. Therefore, even if 40 second candidate documents are derived in descending order of the first similarity from the first candidate documents, documents having the first similarity of equal to or less than 0.4 may be excluded from the second candidate documents, and in this case, less than 40 second candidate documents may be derived.

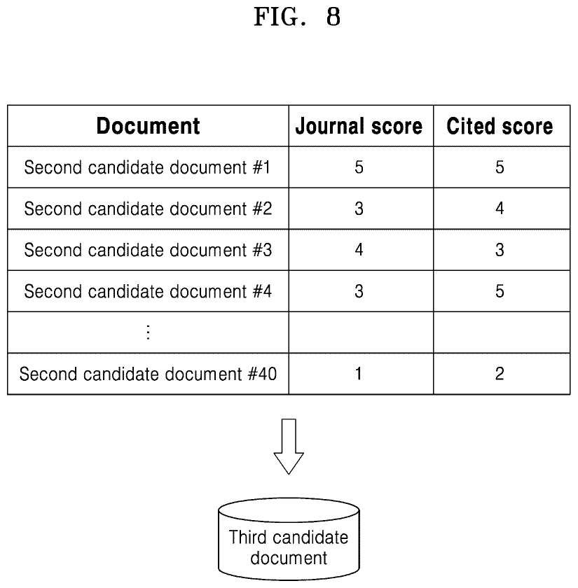

FIG. 8 is a view schematically illustrating a process of performing a third candidate document deriving step according to one embodiment of the present invention.

The third candidate document deriving step may derive a predetermined third number of third candidate documents based on a score derived from metadata of the second candidate document.

Specifically, the third candidate document deriving step may include: a step of extracting metadata from each of the second candidate documents by inputting the second candidate documents into the large language model 3000 that is located outside or inside the server system 1000; a step of calculating a journal score and a cited score for each of the second candidate documents based on the metadata; and a step of deriving a predetermined third number of third candidate documents from the second candidate documents based on the journal score and the cited score.

As illustrated in FIG. 8, after the metadata is extracted from each of the 40 second candidate documents including second candidate documents #1 to #40, the journal score and the cited score for each of the second candidate documents may be calculated based on the metadata.

In this case, when the metadata is extracted by inputting the second candidate documents into the large language model 3000, a prompt for extracting the metadata from the second candidate documents may be input together into the large language model 3000.

In this case, the metadata may include year information, grade information, language information, and field information, and the question text may include information capable of setting year information such as “for the last five years”, information capable of setting grade information such as “in an SCI-level paper”, information capable of setting language information or national information such as “in the United States”, and information capable of setting field information such as “in the AI field”.

When a document related to the question text is searched, the metadata may include all information capable of filtering the document, may include all information capable of calculating the journal score and the cited score, and may include all specific information or rough information, so that the server system 1000 may calculate a score including the journal score and the cited score based on the metadata, and may collect the filtered documents based on the metadata.

For example, the journal score of each of second candidate document #1, second candidate document #2, second candidate document #3, and second candidate document #4 to the second candidate document #40 may correspond to 5, 3, 4, 3, . . . , 1, respectively, and the cited score may correspond to 5, 4, 3, 5, . . . , 2, respectively.

Preferably, the predetermined third number of third candidate documents may be derived from the second candidate documents in descending order of the sum of the journal score and the cited score is high.

According to one embodiment of the present invention, the journal score is a score for evaluating the influence on the corresponding document, and may correspond to a score calculated based on the relative average influence on papers for 5 years after being published in the journal. The journal score may include AI Score, CiteScore, SCImago Journal Rank (SJR), and Source Normalized Impact per Paper (SNIP), or may be calculated based on AI Score, CiteScore, SJR, and SNIP.

In addition, the cited score is a score for analyzing the number of times the corresponding document is cited and evaluating the importance of the corresponding document, and may correspond to a score calculated based on the number of papers published in the corresponding journal and the number of times the papers cited for a specific period, and the cited score may include Impact Factor and Eigenfactor Score or may be calculated based on Impact Factor and Eigenfactor Score.

For example, the score may be calculated based on a score calculated by dividing the number of times a paper in the corresponding journal has been cited in another paper over the past two years by the total number of papers published in the corresponding journal, and the cited score may vary every year. That is, through the cited score, the value or influence of the corresponding document may be determined or the reliability may be verified, and the trend of the last two years may be grasped.

$$log ( Cited Number + 1 ) * {e}^{( Current Year - Publication Year ) * Attenuation Coefficient )} \qquad [ Equation 1 ]$$

According to one embodiment of the present invention, the cited score may be calculated according to [Equation 1]. In this case, an attenuation coefficient of 0.05 may be applied for 5 years after publication, an attenuation coefficient of 0.02 may be applied for 5 to 15 years after publication, and an attenuation coefficient of 0.005 may be applied when 15 years have elapsed after publication.

For example, as for a document published 10 years ago, an attenuation coefficient of 0.05 may be applied for the initial 5 years, an attenuation coefficient of 0.02 may be applied for the subsequent 5 years, and as for a document published 20 years ago, an attenuation coefficient of 0.05 may be applied for the initial 5 years, an attenuation coefficient of 0.02 may be applied for the subsequent 10 years, and an attenuation coefficient of 0.005 may be applied for the remaining 5 years.

Preferably, the journal score and the cited score may be derived while being converted into a number between 1 and 5, and a reliable document may be searched based on the journal score and the cited score.
when the sum of the journal score and the cited score is calculated for each of second candidate documents in FIG. 8, second candidate document #1 may be calculated as 10, second candidate document #2 may be calculated as 7, second candidate document #3 may be calculated as 7, second candidate document #4 may be calculated as 8, . . . , and second candidate document #40 may be calculated as 3. Accordingly, the predetermined third number of third candidate documents may be derived from the second candidate documents, and when the predetermined third number corresponds to 25, 25 third candidate documents may be derived from the second candidate documents in descending order of the value obtained by adding the journal score and the cited score.

However, according to another embodiment of the present invention, the second candidate document in which the sum of the journal score and the cited score is equal to or less than a predetermined reference value may be excluded from the third candidate document. When the predetermined reference value corresponds to 4, the second candidate document in which the sum of the journal score and the cited score is equal to or less than 4 may be excluded from the third candidate document. Therefore, even if 25 third candidate documents are derived in descending order of the sum of the journal score and the citation score from the second candidate documents, a document in which the sum of the journal score and the citation score is equal to or less than 4 may be excluded from the third candidate document, and in this case, less than 25 third candidate documents may be derived.

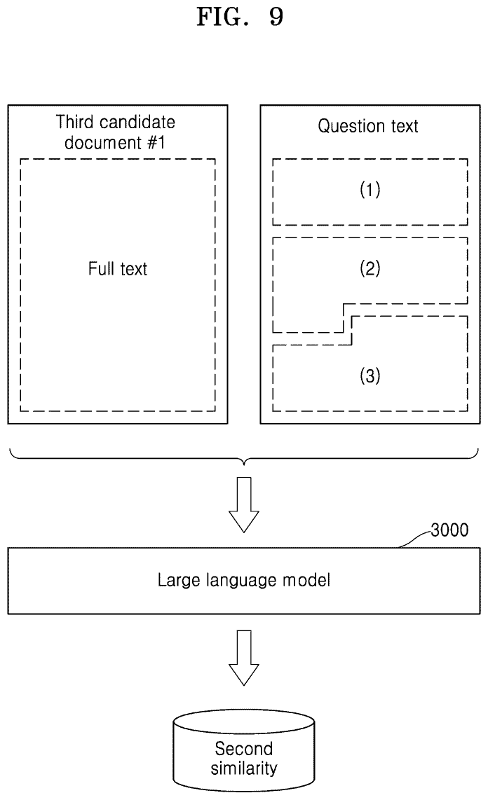

FIG. 9 schematically illustrates a process of performing a second similarity deriving step according to one embodiment of the present invention.

Schematically, in the final candidate document, a final candidate document may be derived based on a second similarity between the cluster and a third region of the third candidate document.

Specifically, the final candidate document deriving step may include: a step of inputting a full text of the third candidate document and the entire cluster into the large language model 3000 that is located outside or inside the server system 1000; a step of deriving a second similarity between each of the third candidate documents and the cluster through the large language model 3000; and a step of deriving final candidates document from the third candidate documents based on the second similarity.

As illustrated in FIG. 9, the second similarity may be derived by inputting the full text of the third candidate document and the entire cluster into the large language model 3000 that is located outside or inside the server system 1000. The second similarity corresponds to a similarity between the full text of the third candidate document and the cluster, and it can be seen that the greater the second similarity, the greater the relevance between the corresponding third candidate document and the corresponding question text. Accordingly, the accuracy of the third candidate document corresponding to the result of verifying the first similarity, the journal score, and the cited score for the title of the document may be determined through the second similarity.

According to one embodiment of the present invention, the second similarity may be derived by inputting each of the third number of third candidate documents and the question text into the large language model 3000, or the second similarity may be derived by inputting each of the third number of third candidate documents and each of clusters included in the question text into the large language model 3000. In this case, a prompt for calculating a similarity between the third candidate document and the question text may be input together into the large language model 3000.

For example, when there are 25 third candidate documents including third candidate documents #1 to #25 and the question text includes three clusters including (1) to (3), the second similarity may be derived by inputting third candidate document #1 and the entire question text into the large language model 3000, or the second similarity may be derived by inputting third candidate document #1 and cluster (1) into the large language model 3000, inputting third candidate document #1 and cluster (2) into the large language model 3000, and inputting third candidate document #1 and cluster (3) into the large language model 3000.

Preferably, the predetermined fourth number of final candidate documents may be derived in descending order of the second similarity from the third candidate documents, or one or more final candidate documents corresponding to equal to or greater than a predetermined second reference similarity may be derived from the third candidate documents.

In this case, according to one embodiment of the present invention, the second similarity may be automatically derived through the large language model 3000, or may be derived by calculating a cosine similarity based on embedding information about the full text of the third candidate document and embedding information about the entire question text.

Therefore, the accuracy of the searched documents may be enhanced by excluding a document including the contents less related to the question text through the second similarity.

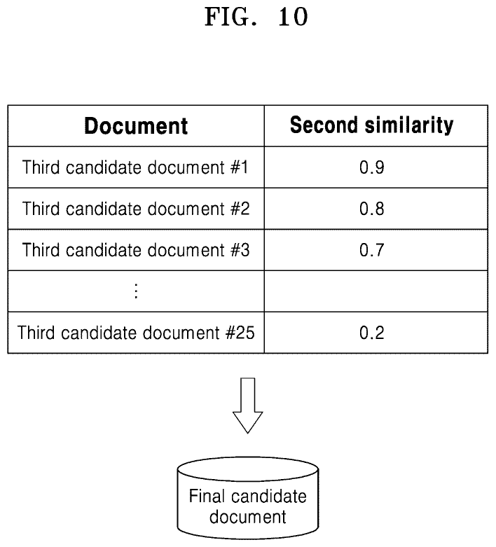

FIG. 10 schematically illustrates a process of performing a final candidate document deriving step according to one embodiment of the present invention.

Schematically, in the final candidate document, a final candidate document may be derived based on a second similarity between the cluster and a third region of the third candidate document.

As illustrated in FIG. 10, as for each of 25 first candidate documents including third candidate documents #1 to #25, a second similarity between the full text of the third candidate document and the question text may be derived, and the second similarity each of third candidate document #1, third candidate document #2, and third candidate document #3 to third candidate document #25 may correspond to 0.9, 0.8, 0.7, . . . , 0.2, respectively.

Preferably, the third area may include the full text of the document, and the second similarity may be derived as a number between 0 and 2.

According to one embodiment of the present invention, the predetermined fourth number of final candidate documents may be derived in descending order of the second similarity from the 25 third candidate documents, and when the predetermined fourth number corresponds to 10, 10 final candidate documents may be derived in descending order of the second similarity from the first candidate documents.

Therefore, 10 final candidate documents including final candidate documents #1 to #10 may be derived.

However, according to another embodiment of the present invention, the final candidate document corresponding to the first similarity that is equal to or less than a predetermined second reference similarity may be excluded from the second candidate document. When the predetermined second reference similarity corresponds to 0.6, the final candidate document corresponding to the second similarity of equal to or less than 0.6 may be excluded from the third candidate document. Therefore, even if 10 final candidate documents are derived in descending order of the second similarity from the third candidate documents, documents having the second similarity of equal to or less than 0.6 may be excluded from the final candidate documents, and in this case, less than 10 final candidate documents may be derived.

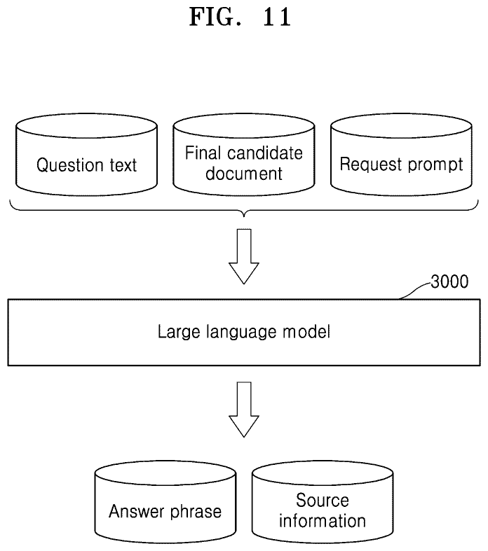

FIG. 11 is a view schematically illustrating a process of performing a report providing step according to one embodiment of the present invention.

Schematically, in the report providing step, a report generated based on the final candidate document may be provided to the user terminal 2000.

Specifically, the report providing step may include: a step of inputting the question text, a text included in the final candidate document, and a request prompt including a request for data to generate a report on the question text into the large language model 3000; a step of receiving a plurality of answer phrases and source information about each answer phrase from the large language model 3000, and generating a report on the question text based on the plurality of answer phrases and the source information; and a step of providing the report to the user terminal 2000.

The report may include: a subject layer L4 including contents of the corresponding question text; a body text layer L5 including contents of the plurality of answer phrases; a source layer L6 including source information about the plurality of answer phrases; and a source element E1 displaying a number for each source information included in the source layer L6, in which the source information may correspond to a source for the final candidate document.

According to one embodiment of the present invention, in the report providing step, an answer similarity may be calculated based on embedding information of each of the plurality of answer phrases and embedding information of the final candidate document referenced by the corresponding answer phrase, and a report displaying the source element E1, which corresponds to source information of the final candidate document referenced by the corresponding answer phrase, may be generated after the answer phrase having the answer similarity that is equal to or greater than a predetermined first reference from among the plurality of answer phrases.

In addition, in the report providing step, a report including the content of the question text, the content of the plurality of answer phrases, and the source information about each answer phrase may be generated using a predetermined template, a report image corresponding to the content of the question text may be generated through the large language model 3000 that generates an image, and a report including the report image may be generated.

As illustrated in FIG. 11, the question text received from the user terminal 2000, a text included in the final candidate document, and a request prompt including a request for data to generate a report on the question text may be input into the large language model 3000 to generate a plurality of answer phrases for generating a report on the question text and source information about each answer phrase, and in this case, the large language model 3000 may correspond to a model for automatically generating an answer to an input question based on the input information and may be located inside or outside the server system 1000.

In addition, the server system 1000 may generate a report on the question text based on the plurality of answer phrases and the source information generated from the large language model 3000, and may provide the generated report to the user terminal 2000. The user may input a question text including a text for a report to be generated into the server system 1000, and may receive a report generated based on the final candidate document related to the question text. After receiving the report on the input question, the user may input a correction request or a question for the report to receive the corrected report or an answer to the question again, or may input a new question text different from the previous question text to repeatedly receive a report on the new question text.

According to one embodiment of the present invention, the request prompt may further include a source information generation request for a final candidate document referenced by the generated answer phrase, and in the report providing step, after the plurality of answer phrases for the question text are generated, and source information about one or more documents referenced by the corresponding answer phrase may be generated from among the final candidate document, and source information corresponding to each answer phrase may be generated.

In addition, the server system 1000 may include a text in the request prompt to “displaying the source of each text reference by the generated answer phrase from among one or more final candidate documents, and generating an answer by annotating document information referenced by the answer phrase for the question text input by the user”.

Accordingly, the question text received from the user terminal 2000, a text included in the final candidate document, and a request prompt including a request for data to generate a report on the question text and a request for generating source information about the final candidate document referenced by the generated answer phrase may be input into the large language model 3000 to generate an answer phrase corresponding to the material for generating the report on the question text, and generate source information about the final candidate document corresponding to a chunk text referenced by the answer phrase.

Preferably, the source information may be generated when a request for displaying a source is received together when the question text is received from the user terminal 2000, or the source information about the answer phrase may always be generated together according to the setting of the server system 1000.

According to another embodiment of the present invention, after selecting the final candidate document in the final candidate document deriving step, information including the title, abstract, and full text of the final candidate document is provided to the user terminal 2000, and the user may select any one or more of the final candidate documents as a document to be referenced by a report to be generated. When receiving a selection input for any one or more of the final candidate documents from the user terminal 2000, the server system 1000 may generate a report based on the final candidate document selected by the user.

In this case, by inputting the question text, the text included in the final candidate document selected from the user terminal 2000, and the request prompt including the request for generating the report for the question text into the large language model 3000, the answer phrase and source information for generating the report on the question text may be generated based on the text included in the final candidate document selected from the user terminal 2000 through the large language model 3000, and the server system 1000 may generate a report based on the answer phrase and the source information, and provide the generated report to the user terminal 2000.

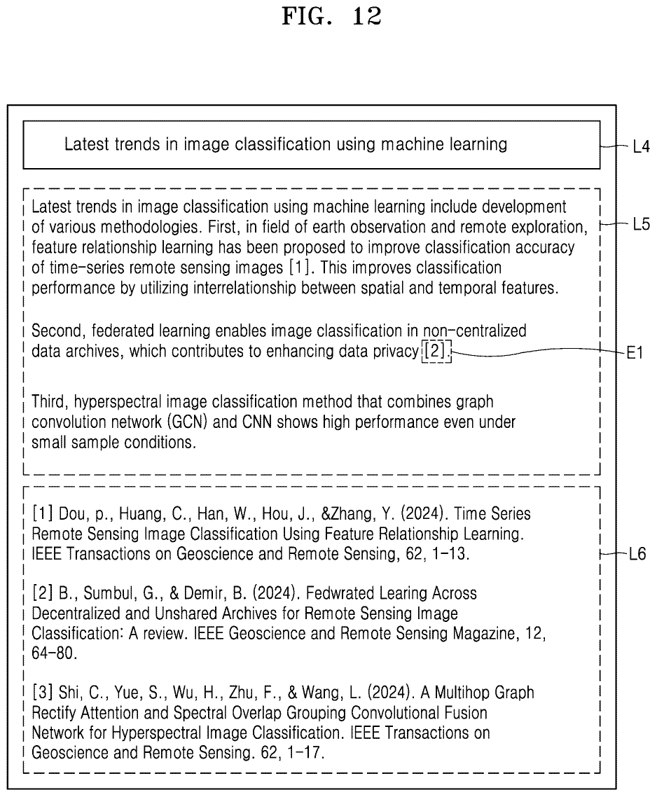

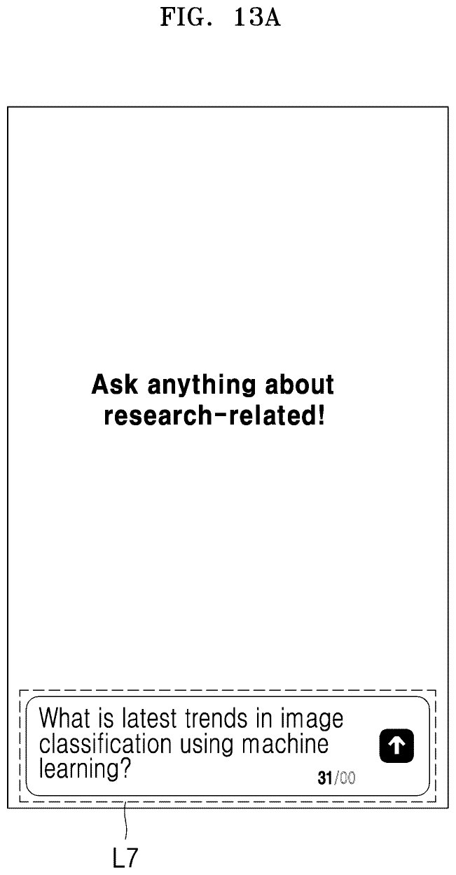

FIG. 12 is a view schematically illustrating a report according to one embodiment of the present invention.

Schematically, the report may include: a subject layer L4 including contents of the corresponding question text; a body text layer L5 including contents of the plurality of answer phrases; a source layer L6 including source information about the plurality of answer phrases; and a source element E1 displaying a number for each source information included in the source layer L6.

Specifically, the source information may correspond to a source for the final candidate document, and the source element E1 corresponding to the source information of the final candidate document referenced by each of the plurality of answer phrases may be displayed after the plurality of answer phrases.

According to one embodiment of the present invention, in the report providing step, an answer similarity may be calculated based on embedding information of each of the plurality of answer phrases and embedding information of the final candidate document referenced by the corresponding answer phrase, and a report displaying the source element E1, which corresponds to source information of the final candidate document referenced by the corresponding answer phrase, may be generated after the answer phrase having the answer similarity that is equal to or greater than a predetermined first reference from among the plurality of answer phrases.

In addition, in the report providing step, a report including the content of the question text, the content of the plurality of answer phrases, and the source information about each answer phrase may be generated using a predetermined template, a report image corresponding to the content of the question text may be generated through the large language model 3000 that generates an image, and a report including the report image may be generated.

Preferably, the report corresponds to a report generated through the server system 1000 or the large language model 3000 based on the plurality of answer phrases and source information generated by the large language model 3000, and may be generated using a predetermined template or a template selected from the user terminal 2000.

According to one embodiment of the present invention, as illustrated in FIG. 12, the predetermined template may correspond to a template in which the title or subject is displayed at an upper end of the report, a body text corresponding to the title or subject is displayed at the center of the report, and source information about the body text is displayed at a lower end of the report.

As illustrated in FIG. 12, the subject layer L4 may include the contents of the question text and display the subject or title of the report.

The body text layer L5 may include a body text of a subject displayed on the subject layer L4, include contents of the plurality of answer phrases generated from the large language model 3000, and display the body text of the report including contents corresponding to the question text input by the user in a text form, and the user may receive an answer to the question text or related contents through the body text layer L5.

The source layer L6 includes source information about each of the plurality of answer phrases. In this case, the source layer L6 may display source information of the corresponding report that shows which document is written with reference to, and may include the title of the document, the author of the document, and the paragraph number of the contents referenced in the contents of the body text layer L5 of the corresponding report.

According to one embodiment of the present invention, the source layer L6 may be displayed under the body text layer L5, and the user terminal 2000 may selectively input each source information displayed on the source layer L6 so that the source layer L6 may be connected to the corresponding document or may download the corresponding document.

In addition, the report may include the source element E1 displaying a number for each source information included in the source layer L6, and the source element E1 corresponding to the source information of the final candidate document referenced by each answer phrase may be displayed after the plurality of answer phrases.

Preferably, when a user who has received the corresponding report online selects and inputs the source element E1, the source information corresponding to the source element E1 displayed on the source layer L6 may be moved, so that the source information may be quickly confirmed.

In the body text layer L5, the plurality of answer phrases are included in each paragraph, and the source element E1 displaying source information about a document referenced by the corresponding paragraph or sentence may be displayed after each paragraph or sentence. That is, the user may quickly and conveniently grasp the document reference by the corresponding paragraph or sentence through the source element E1.

In addition, in the report providing step, an answer similarity may be calculated based on embedding information of each of the plurality of answer phrases and embedding information of the final candidate document referenced by the corresponding answer phrase, and a report displaying the source element E1, which corresponds to source information of the final candidate document referenced by the corresponding answer phrase, may be generated after the answer phrase having the answer similarity that is equal to or greater than a predetermined first reference from among the plurality of answer phrases.

When each of the plurality of answer phrases is displayed as one paragraph in the body text layer L5 of the report and each answer phrase corresponds to one source information, the body text layer L5 includes each paragraph displaying each of the plurality of answer phrases in a text form, and the source element E1 corresponding to the source of the corresponding paragraph may be displayed after each paragraph.

In this case, three paragraphs including paragraphs #1 to #3 exist in the body layer L5, and when each paragraph corresponds to one answer phrase, an answer similarity may be calculated based on embedding information of each answer phrase and embedding information of the final candidate document corresponding to the source element E1 displayed after the corresponding paragraph.

Thereafter, from among three answer phrases corresponding to paragraphs #1 to #3, when answer phrases having the answer similarity of equal to or greater than a predetermined first reference corresponds to paragraphs #1 to #3 and the answer similarity of paragraph #3 is less than the predetermined first reference, the source element E1 corresponding to the source information of the final candidate document referenced by the corresponding answer phrase may be displayed after paragraphs #1 and #2, and the source element E1 may not be displayed after paragraphs #3.

In addition, according to one embodiment of the present invention, as illustrated in FIG. 12, a report including only a text form may be generated through the document search method of the present invention, and a report including an image may be generated according to the setting of the user terminal 2000 or the server system 1000. In this case, after the report is generated, a report image corresponding to the contents of the question text and the contents of the report may be generated through the large language model 3000 that generates an image, and the report image may be added to the report, so that a report including the report image may be generated and the generated report may be provided to the user terminal 2000.

In the document search method of the present invention, a document including keywords for the question text may be searched through the first candidate document deriving step, a document having the title similar to the question text may be filtered based on the first similarity through the second candidate document deriving step, a reliable document may be filtered based on a score derived from the metadata through the third candidate document deriving step, and a document including an answer to the question text may be filtered based on the second similarity through the final candidate document deriving step.

Therefore, the documents are filtered through a plurality of steps, so that it is possible to search a document in a manner that maximizes the accuracy while reducing an amount of computation of the server system 1000. That is, through these steps, a final candidate document having verified reliability and accuracy may be derived, and a report based on the final candidate document may be generated, so that the user may be provided with a final candidate document related to the corresponding question text through the question text input, and may be provided with a report related to the question text.

In the document search method of the present invention, a question text of a long natural language received from the user may be analyzed, and the question text may be converted into an optimal search query to derive a final candidate document including an academic paper. After the large language model 3000 and the traditional NLP technique are used to process the question text input by the user, relevance and reliability may be evaluated by applying a multi-scoring method to documents searched from the academic database, and finally, information about the filtered final candidate document may be provided to the user, thereby maximizing research efficiency and quickly providing academic information with high accuracy.

In addition, by providing the user with a report generated based on the final candidate document, the user may obtain an in-depth understanding of a specific research subject and may be conveniently provided with a report on the specific research subject.

That is, through the present invention, a long natural language query may be processed and converted into a query optimized to be searchable, a document having high quality and relevance may be selected from among the searched documents, an optimal result may be provided to the user by integrating multiple scoring such as semantic similarity, journal influence, and the number of citations, and the reliability of a search result and a user's demand may be satisfied at the same time.

Accordingly, a document may be searched by analyzing the question text input by the user and generating a search query for the question text, a document having reliability and accuracy may be filtered, a final candidate document of high quality may be derived, and a report may be generated based on the final candidate document.

According to one embodiment of the present invention, when the source element E1 is selectively input by the user terminal, the source element E1 may be connected to the source information displayed on the source layer L6, and when the source information displayed on the source layer L6 is selectively input, the source information displayed on the source layer L6 may be connected to a document corresponding to the source information in a hyperlink form.

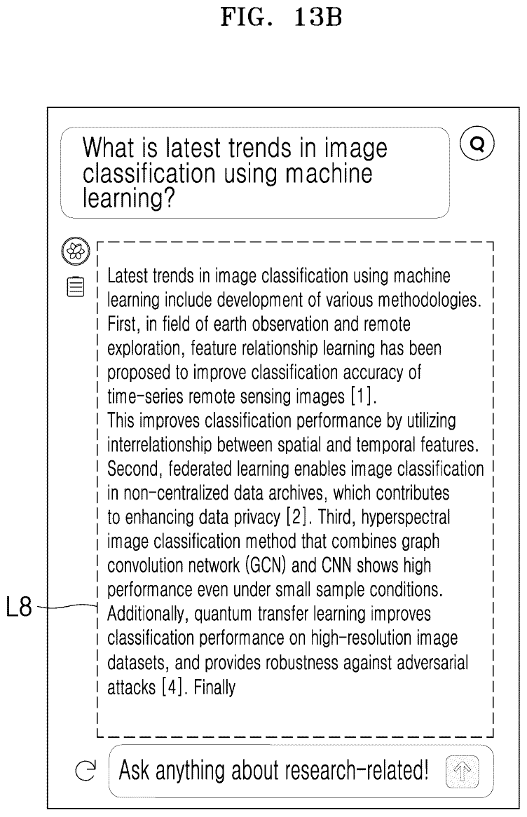

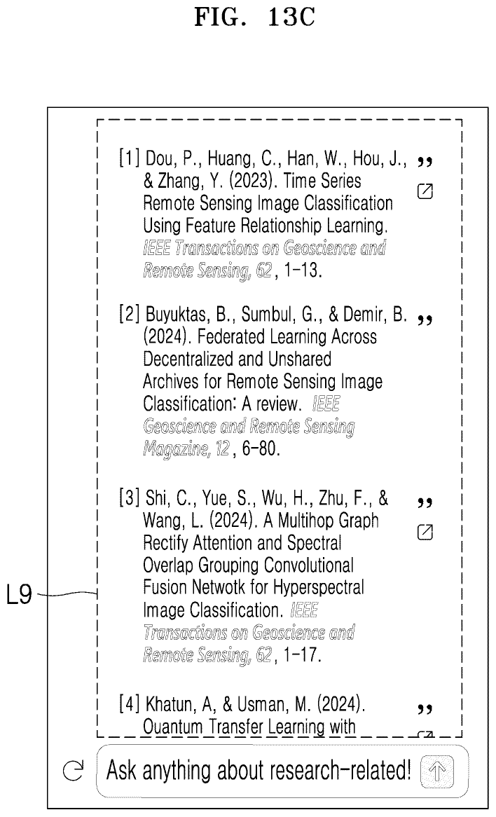

FIGS. 13A-13C schematically illustrate chatbot interfaces according to one embodiment of the present invention.

FIG. 13A illustrates a chatbot question input layer L7, FIG. 13B illustrates a chatbot answer providing layer L8, and FIG. 13C illustrates a chatbot source providing layer L9.

Specifically, the chatbot interface includes a chatbot question input layer L7 for receiving the question text from the user terminal 2000; the chatbot answer providing layer L8 for providing an answer text to the question text to the user terminal 2000; and the chatbot source providing layer L9 for providing source information about the answer text to the user terminal 2000.

Preferably, the chatbot interface is an interface through which the user terminal 2000 may input a question, transmit an answer request for the question to the server system 1000, and receive an answer for the question, and the user may chat with the server system 1000 or the corresponding chatbot through the chatbot interface.

As illustrated in FIG. 13A, the chatbot question input layer L7 may receive the question text from the user device 2000, and may correspond to a first screen displayed when the chatbot interface is displayed on the user terminal 2000. The user provided with the chatbot interface may input a research-related question in a text form through the chatbot question input layer L7.

As illustrated in FIG. 13B, the chatbot answer providing layer L8 may provide the answer text to the user device 2000, and may correspond to a screen displayed after the user inputs the question text into the chatbot interface. The answer to the question text input by the user may be displayed in a text form, and the user may receive the answer to the question text through the chatbot answer providing layer L8.

As illustrated in FIG. 13C, the chatbot source providing layer L9 may provide the source information about the answer text to the user device 2000, and may correspond to a screen displayed after the user receives the answer text through the chatbot interface. The chatbot source providing layer L9 may display source information of the displayed answer text that shows which document is written with reference to, and may include the title of the document, the author of the document, and the paragraph number of the contents referenced in the answer text.

According to one embodiment of the present invention, the chatbot source providing layer L9 may be displayed under the chatbot answer providing layer L8, and the user terminal 2000 may selectively input each source information displayed on the chatbot source providing layer L9 so that the chatbot source providing layer L9 may be connected to the corresponding document or may download the corresponding document.

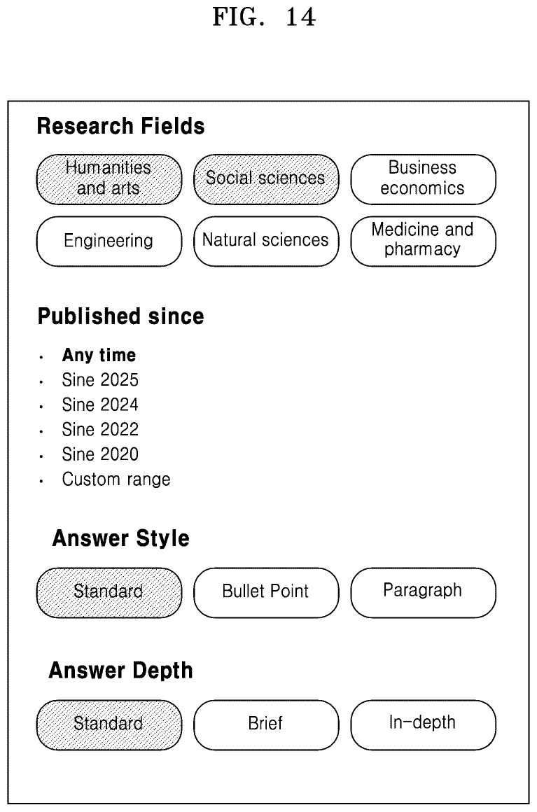

FIG. 14 is a view schematically illustrating a search filter interface according to one embodiment of the present invention.

Schematically, the search filter interface is an interface that may set a filter for a document to be searched when a question is input to the search interface in the user terminal 2000, and may be displayed on the user terminal 2000 together with the search interface shown in FIGS. 3A and 3B.

Specifically, the user may input the question through the search interface, and through the search filter interface, the user may select a category for a final candidate document to be searched, select a document generation date, select an answer style, and select an answer depth.

Preferably, when an answer to the question input by the user or a related document is provided to the user terminal, the answer may be generated or the document may be searched based on the category, the document generation date, the answer style, and the answer depth input by the user through the search filter interface.

As illustrated in FIG. 14, when categories including humanities and arts, social sciences, business economics, engineering, natural sciences, and medicine and pharmacy are displayed through the search filter interface, the user may select one or more of the categories. If a category is selected by the user, only documents included in the category may be searched when a final candidate document based on the question text may be searched.

For example, as illustrated in FIG. 14, when the user selects humanities and arts and social sciences, a final candidate document may be derived from the documents included in the categories.

In this case, the category may include various categories including a Research Field as illustrated in FIG. 14.

When a document generation date including this year, one year ago, three years ago, five years ago, and a user-set year is displayed through the search filter interface, the user may select one of the generation dates of the corresponding document, and when the user-set year is selected, the user may directly input the year. If a document generation date is selected by the user, only documents related to the document generation date may be searched when a final candidate document based on the question text may be searched.

For example, as illustrated in FIG. 14, when a current time point is 2025, a document generation date including Any time, Since 2025, Since 2024, Since 2022, Since 2020, and Custom range may be displayed, and when the user selects Any time, a final candidate document may be derived from all documents corresponding to the document generation date.

In addition, when an answer style including Standard, Bullet Point, and Paragraph is displayed through the search filter interface, the user may select one of the answer styles. When the answer style is selected by the user, a final candidate document may be searched based on the question text and an answer to the question text may be provided to the user, or when a report generated using the final candidate document is provided, an answer or a report generated to correspond to the answer style may be provided.

For example, as illustrated in FIG. 14, when the user selects Standard, an answer corresponding to the answer style may be generated and provided to the user terminal 2000.

When the answer depth including Standard, Brief, and In-depth is displayed through the search filter interface, the user may select one of the answer depths. When the answer depth is selected by the user, a final candidate document may be searched based on the question text and an answer to the question text may be provided to the user, or when a report generated using the final candidate document is provided, an answer or a report generated to correspond to the answer depth may be provided.

For example, as illustrated in FIG. 14, when the user selects Standard, an answer corresponding to the answer depth may be generated and provided to the user terminal 2000.

According to one embodiment of the present invention, in this case, the user terminal 2000 may receive an answer including the source information according to the selection, and may receive an answer not including the source information. The user may input a selection for the source information in the form of an on/off, and may receive an answer according to the user's selection input.

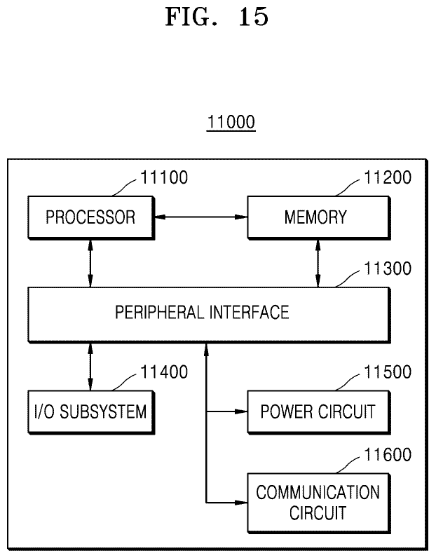

FIG. 15 schematically shows internal components of the computing device according to one embodiment of the present invention.

The server system 1000 shown in the above-described FIGS. 1A and 1B may include components of the server system 11000 shown in FIG. 15.

As shown in FIG. 15, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the server system 1000 shown in FIGS. 1A and 1B.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 15 is merely an example of the computing device 11000, and the computing device 11000 may have a configuration or arrangement in which some components shown in FIG. 15 are omitted, additional components not shown in FIG. 15 are further provided, or at least two components are combined. For example, a computing device for a communication terminal in a mobile environment may further include a touch screen, a sensor or the like in addition to the components shown in FIG. 15, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vise versa.

According to one embodiment of the present invention, it is possible to derive final candidate documents related to the question text from the plurality of documents.

According to one embodiment of the present invention, it is possible to generate a report based on the final candidate documents through the large language model.

According to one embodiment of the present invention, it is possible to extract a document having a high similarity with the question text by calculating the first similarity and the second similarity.

According to one embodiment of the present invention, it is possible to verify reliability of the document by deriving a score from metadata of the document.

According to one embodiment of the present invention, it is possible to search a document related to the question text by deriving keywords from the question text.

According to one embodiment, it is possible to verify reliability of the report through source information about the final candidate document referenced by the report.

According to one embodiment of the present invention, a user may provide a related document by inputting the question text through the search interface.

According to one embodiment, it is possible to derive a first similarity, a second similarity, and metadata through the large language model.

According to one embodiment of the present invention, it is possible to calculate a journal score and a cited score based on metadata of the document.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

1. A method for searching, at an academic information search engine, a document having a title and an abstract of a full text based on artificial intelligence, the method comprising:
a step of receiving a question text from a user terminal through a search interface at the academic information search engine;
a step of separating the question text into one or more clusters by inputting the question text into a cluster division model of a server system;
a step of deriving keywords from each of the one or more clusters by inputting each of the clusters into a large language model that is located outside or inside the server system;
a step of deriving a weight for each of the keywords based on a frequency of the keywords included in the question text;
a first candidate document deriving step of deriving a predetermined first number of first candidate documents by searching the titles and the abstracts, rather than the full texts, of a plurality of documents based on the keywords and the weight for each keyword;
a step of inputting the title of each of the first candidate documents and the entire clusters into the large language model;
a step of deriving a first similarity between the title of each of the first candidate documents and the clusters through the large language model;
a step of deriving a predetermined second number of second candidate documents from the first candidate documents based on the first similarity;
a step of extracting metadata from each of the second candidate documents by inputting the second candidate documents into the large language model;
a step of calculating a journal score and a cited score for each of the second candidate documents based on the metadata;
a step of deriving a predetermined third number of third candidate documents from the second candidate documents based on the journal score and the cited score;
a step of inputting the full text of each of the third candidate documents and the entire clusters into the large language model;
a step of deriving a second similarity between the full text of each of the third candidate documents and the clusters through the large language model; and
a step of deriving final candidate documents from the third candidate documents based on the second similarity.

2-6. (canceled)

7. The method of claim 1, further comprising:
a report providing step of providing a report generated based on the final candidate documents to the user terminal,
wherein the report providing step includes:
a step of inputting the question text, a text included in the final candidate documents, and a request prompt including a request for data to generate the report on the question text into a large language model;
a step of receiving a plurality of answer phrases and source information about each answer phrase from the large language model, and generating the report on the question text based on the plurality of answer phrases and the source information; and
a step of providing the report to the user terminal.
